(19) United States
(12) Patent Application Publication
(10) Pub. No.: US 2016/0196811 A1
(43) Pub. Date: Jul. 7, 2016

(54) Electronic Cymbal With Multiple Detection Zones

(71) Applicant: Al-Musics Technology Inc., New Taipei City (TW)

(72) Inventor: Hsin-Yu Shen, New Taipei City (TW)

(21) Appl. No.: 14/591,795

(22) Filed: Jan. 7, 2015

(51) Int. Cl. G10D 13/06

(52) U.S. Cl. CPC G10D 13/06

(57) ABSTRACT

Various implementations of an electronic percussion instrument are provided. In one aspect, an electronic percussion instrument may include an electronic cymbal assembly which may include a main cymbal seat, a percussion detection module and an electronics module. The main cymbal seat may include multiple percussion zones. The percussion detection module may be disposed on the main cymbal seat, and may be configured to detect percussion of one or more of the multiple percussion zones to generate a first signal in response to the detecting. The electronics module may be communicatively coupled to receive the first signal from the percussion detection module to provide a second signal configured to generate an electronic percussion sound.

### TECHNICAL FIELD

The present disclosure relates to the field of electronic musical instruments and, more particularly, to electronic percussion instruments.

### BACKGROUND

Unless otherwise indicated herein, approaches described in this section are not prior art to the claims listed below and are not admitted to be prior art by inclusion in this section.

There are various types of electronic musical instruments including electronic percussion instruments, such as an electronic cymbal. In a conventional electronic cymbal, a piezoelectric sensor is typically disposed on the rubber pad. The range of signal detection of the piezoelectric sensor is small, especially when compared to the size of the percussion area of the cymbal. This may not be a significant issue if and when the size of the percussion area of the drum pad or cymbal is also small. However, an electronic cymbal in a 1:1 scale relative to a non-electronic cymbal has a relatively larger percussion area and, consequently, sensitivity of the piezoelectric sensor with respect to percussions on the peripheral region of the percussion area may be diminished. Further, vibrations caused by percussions on the percussion area as sensed by the piezoelectric sensor and a signal generated by the piezoelectric sensor for generation of an electronic percussion sound may be unstable. An electronic sound thus generated tends to be less than ideal.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

The present disclosure provides various implementations of an electronic percussion instrument, such as an electronic cymbal. Compared with existing electronic percussion instruments, an electronic percussion instrument according to the present disclosure produces signals with improved stability for electronic sound generation. Additionally, an electronic percussion instrument according to the present disclosure offers an increased range of signal detection with respect to the size of percussion area.

In one aspect, an electronic percussion instrument may include an electronic cymbal assembly which may include a main cymbal seat, a percussion detection module and an electronics module. The main cymbal seat may include a first primary side and a second primary side opposite the first primary side. The main cymbal seat may also include a plurality of percussion zones. The percussion detection module may be disposed on the main cymbal seat, and may be configured to detect percussion of one or more of the plurality of percussion zones to generate a first signal in response to the detecting. The electronics module may be communicatively coupled to receive the first signal from the percussion detection module and configured to provide a second signal configured to generate an electronic percussion sound.

In at least some implementations, the percussion detection module may include a plurality of sensors each of which corresponding to a respective one of the plurality of percussion zones.

In at least some implementations, the plurality of sensors may include a first sensor, a second sensor and a third sensor. The first sensor may be disposed in a first percussion zone of the plurality of percussion zones on a bell-shaped portion of the main cymbal seat. The third sensor may be disposed in a third percussion zone of the plurality of percussion zones along a rim of the main cymbal seat. The second sensor may be disposed in a second percussion zone of the plurality of percussion zones between the first percussion zone and the third percussion zone of the main cymbal seat.

In at least some implementations, the first sensor and the third sensor may be disposed on the first primary side of the main cymbal seat. The second sensor may be disposed on the second primary side of the main cymbal seat.

In at least some implementations, the first sensor may be tapered such that a normal of a primary sensing surface of the first sensor is offset from a normal of the first primary side of the main cymbal seat.

In at least some implementations, the main cymbal seat may further include at least one rib protruding out of the second primary side thereof.

In at least some implementations, the at least one rib may include a plurality of ribs arranged in a mesh-like pattern.

In at least some implementations, the main cymbal seat may further include a capsule-shaped through-hole in a middle portion thereof. The capsule-shaped through-hole may be configured such that, when the electronic cymbal assembly is installed on a shaft of a conventional cymbal stand with the shaft traversing through the capsule-shaped through-hole, the capsule-shaped through-hole prevents the electronic cymbal assembly from spinning around the shaft.

In at least some implementations, the electronic percussion instrument may further include first and second counter-weight pieces mounted on the second primary side of the main cymbal seat. The first counter-weight piece may be configured to balance a weight of the electronic cymbal assembly when the electronic cymbal assembly swings when being percussed. The second counter-weight piece may be configured to reduce vibration of at least the main cymbal seat.

In at least some implementations, the electronic percussion instrument may further include an elastic percussion pad disposed on the first primary side of the main cymbal seat with one or more sensors of the percussion detection module disposed between the elastic percussion pad and the main cymbal seat.

In at least some implementations, at least a portion of a surface of the elastic percussion pad that faces the main cymbal seat may include at least one rib configured to be in physical contact with at least one sensor of the percussion detection module.

In at least some implementations, the at least one rib of the elastic percussion pad may include a plurality of concentric ribs configured to be disposed on and around a bell-shaped portion of the main cymbal seat.

In at least some implementations, the electronic percussion instrument may further include an anti-spin module that may include a lock rim, a rubber holder seat, a lower rubber holder and an upper rubber holder. The lock rim may include a through-hole and configured to be installed on a shaft of a conventional cymbal stand with the shaft traversing through the through-hole of the lock rim. The lock rim may also include two trenches. The rubber holder seat may be configured to be installed on the shaft of the conventional cymbal stand. The rubber holder seat may include two ribs configured to be accommodated in the two trenches of the lock rim when the rubber holder seat is installed on the shaft. The rubber holder seat may also include a first collar protruding in a direction along the shaft when the rubber holder seat is installed on the shaft. The lower rubber holder may include a through-hole that fits around the first collar of the rubber holder seat when the lower rubber holder is installed on the shaft. The lower rubber holder may include a second collar protruding in a direction along the shaft when the lower rubber holder is installed on the shaft. The second collar may include a capsule-shaped cross-sectional profile configured to fit in the capsule-shaped through-hole of the main cymbal seat. The upper rubber holder may be configured to be installed on the shaft of the conventional cymbal stand such that the electronic cymbal assembly is disposed between the upper rubber holder and the lower rubber holder.

In another aspect, an electronic percussion instrument may include an electronic cymbal assembly which may include a main cymbal seat, a percussion detection module and an electronics module. The main cymbal seat may include a first primary side and a second primary side opposite the first primary side. The main cymbal seat may also include a capsule-shaped through-hole and configured to be installed on a shaft of a conventional cymbal stand with the shaft traversing through the capsule-shaped through-hole such that the capsule-shaped through-hole prevents the electronic cymbal assembly from spinning around the shaft. The percussion detection module may be disposed on the main cymbal seat and configured to detect percussion of the main cymbal seat to generate a first signal in response to the detecting. The electronics module may be communicatively coupled to receive the first signal from the percussion detection module and configured to provide a second signal configured to generate an electronic percussion sound.

In at least some implementations, the main cymbal seat may further include a plurality of percussion zones. The percussion detection module may be configured to detect percussion of one or more of the plurality of percussion zones.

In at least some implementations, the percussion detection module may include a plurality of sensors each of which corresponding to a respective one of the plurality of percussion zones.

In at least some implementations, the plurality of sensors may include a first sensor, a second sensor and a third sensor. The first sensor may be disposed in a first percussion zone of the plurality of percussion zones on a bell-shaped portion of the main cymbal seat. The third sensor may be disposed in a third percussion zone of the plurality of percussion zones along a rim of the main cymbal seat. The second sensor may be disposed in a second percussion zone of the plurality of percussion zones between the first percussion zone and the third percussion zone of the main cymbal seat.

In at least some implementations, the first sensor and the third sensor may be disposed on the first primary side of the main cymbal seat. The second sensor may be disposed on the second primary side of the main cymbal seat.

In at least some implementations, the first sensor may be tapered such that a normal of a primary sensing surface of the first sensor is offset from a normal of the first primary side of the main cymbal seat.

In at least some implementations, the main cymbal seat may further include at least one rib protruding out of the second primary side thereof.

In at least some implementations, the at least one rib may include a plurality of ribs arranged in a mesh-like pattern.

In at least some implementations, the electronic percussion instrument may further include first and second counter-weight pieces mounted on the second primary side of the main cymbal seat. The first counter-weight piece may be configured to balance a weight of the electronic cymbal assembly when the electronic cymbal assembly swings when being percussed. The second counter-weight piece may be configured to reduce vibration of at least the main cymbal seat.

In at least some implementations, the electronic percussion instrument may further include an elastic percussion pad disposed on the first primary side of the main cymbal seat with one or more sensors of the percussion detection module disposed between the elastic percussion pad and the main cymbal seat.

In at least some implementations, at least a portion of a surface of the elastic percussion pad that faces the main cymbal seat may include at least one rib configured to be in physical contact with at least one sensor of the percussion detection module.

In at least some implementations, the at least one rib of the elastic percussion pad may include a plurality of concentric ribs configured to be disposed on and around a bell-shaped portion of the main cymbal seat.

In at least some implementations, the electronic percussion instrument may further include an anti-spin module that may include a lock rim, a rubber holder seat, a lower rubber holder and an upper rubber holder. The lock rim may include a through-hole and configured to be installed on a shaft of a conventional cymbal stand with the shaft traversing through the through-hole of the lock rim. The lock rim may also include two trenches. The rubber holder seat may be configured to be installed on the shaft of the conventional cymbal stand. The rubber holder seat may include two ribs configured to be accommodated in the two trenches of the lock rim when the rubber holder seat is installed on the shaft. The rubber holder seat may also include a first collar protruding in a direction along the shaft when the rubber holder seat is installed on the shaft. The lower rubber holder may include a through-hole that fits around the first collar of the rubber holder seat when the lower rubber holder is installed on the shaft. The lower rubber holder may include a second collar protruding in a direction along the shaft when the lower rubber holder is installed on the shaft. The second collar may include a capsule-shaped cross-sectional profile configured to fit in the capsule-shaped through-hole of the main cymbal seat. The upper rubber holder may be configured to be installed on the shaft of the conventional cymbal stand such that the electronic cymbal assembly is disposed between the upper rubber holder and the lower rubber holder.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a top perspective view of an electronic cymbal assembly of an electronic percussion instrument in accordance with an implementation of the present disclosure.

FIG. 2 is a bottom perspective view of an electronic cymbal assembly of an electronic percussion instrument in accordance with an implementation of the present disclosure.

FIG. 3 is a top view of an electronic cymbal assembly of an electronic percussion instrument in accordance with an implementation of the present disclosure.

FIG. 4 is a cross-sectional view of an electronic cymbal assembly of an electronic percussion instrument in accordance with an implementation of the present disclosure.

FIG. 5 is a top view of multiple percussion zones of a main cymbal seat of an electronic cymbal assembly of an electronic percussion instrument in accordance with an implementation of the present disclosure.

FIG. 6 is a first exploded view of an electronic cymbal assembly of an electronic percussion instrument in accordance with an implementation of the present disclosure.

FIG. 7 is a second exploded view of an electronic cymbal assembly of an electronic percussion instrument in accordance with an implementation of the present disclosure.

FIG. 8 is a cross-sectional view of an electronic cymbal assembly of an electronic percussion instrument in accordance with an implementation of the present disclosure.

FIG. 9 is an enlarged view of a portion of a cross section of the electronic cymbal assembly of FIG. 8.

FIG. 10 is a bottom perspective view of a main cymbal seat of an electronic cymbal assembly of an electronic percussion instrument in accordance with an implementation of the present disclosure.

FIG. 11 is a bottom view of the main cymbal seat of FIG. 10.

FIG. 12 is a cross-sectional view of an electronic cymbal assembly of an electronic percussion instrument in accordance with an implementation of the present disclosure.

FIG. 13 is a bottom view of the electronic cymbal assembly of FIG. 12.

FIG. 14 is a top view of an electronic cymbal assembly of an electronic percussion instrument in accordance with an implementation of the present disclosure.

FIG. 15 is a diagram of comparison of charts of detected signals by different electronic cymbal assemblies.

FIG. 16 is an exploded view of an anti-spin module of an electronic percussion instrument in accordance with an implementation of the present disclosure.

FIG. 17 is an assembly view of the anti-spin module of FIG. 16 installed on a tilter shaft of a conventional cymbal stand in accordance with an implementation of the present disclosure.

FIG. 18 is a perspective view of an electronic cymbal assembly installed with the anti-spin module of FIG. 16 on a tilter shaft of a conventional cymbal stand in accordance with an implementation of the present disclosure.

FIG. 19 is a top perspective view of an electronic cymbal assembly of an electronic percussion instrument in accordance with an implementation of the present disclosure.

FIG. 20 is a bottom perspective view of an electronic cymbal assembly of an electronic percussion instrument in accordance with an implementation of the present disclosure.

FIG. 21 is a first exploded view of an electronic cymbal assembly of an electronic percussion instrument in accordance with an implementation of the present disclosure.

FIG. 22 is a second exploded view of an electronic cymbal assembly of an electronic percussion instrument in accordance with an implementation of the present disclosure.

### DETAILED DESCRIPTION OF PREFERRED IMPLEMENTATIONS

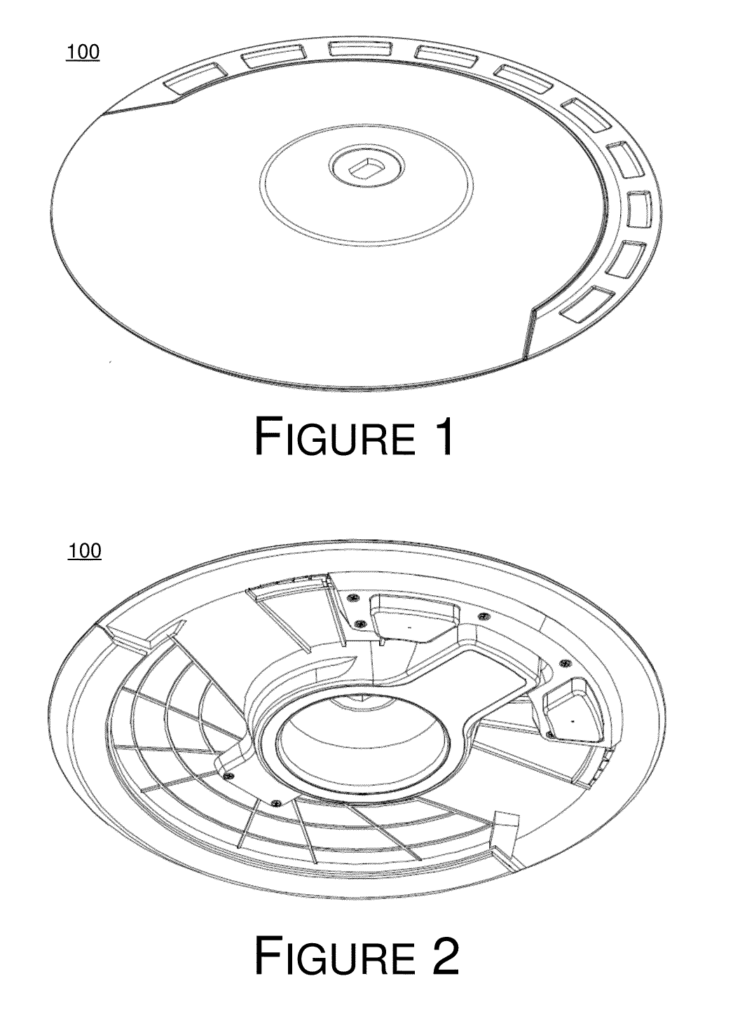

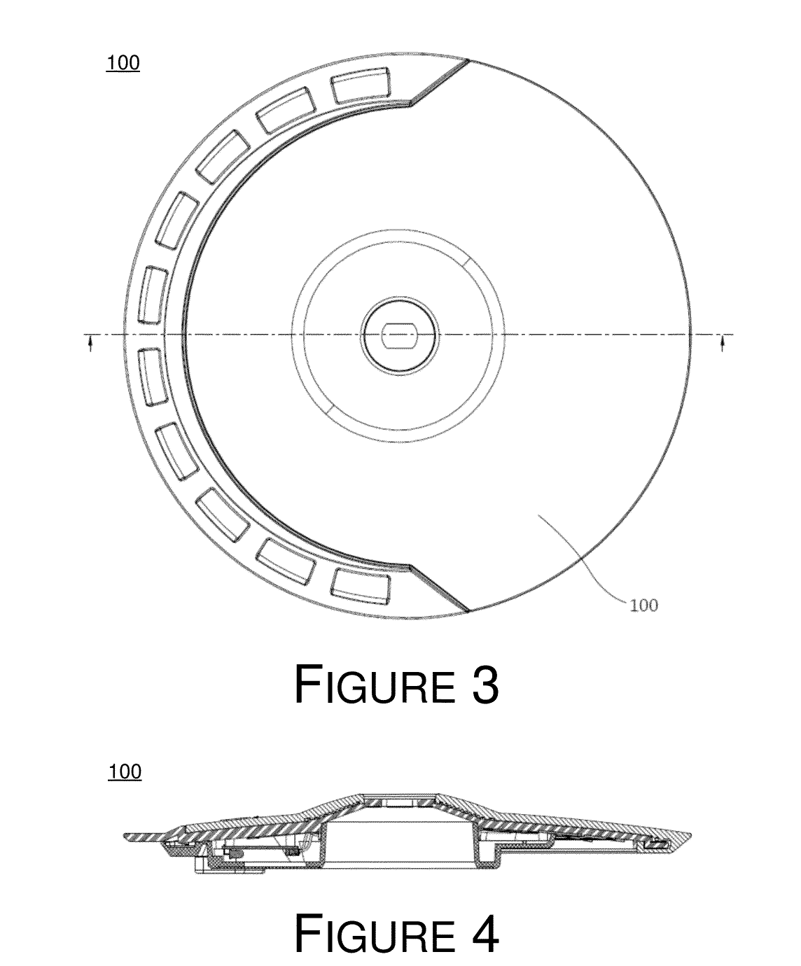

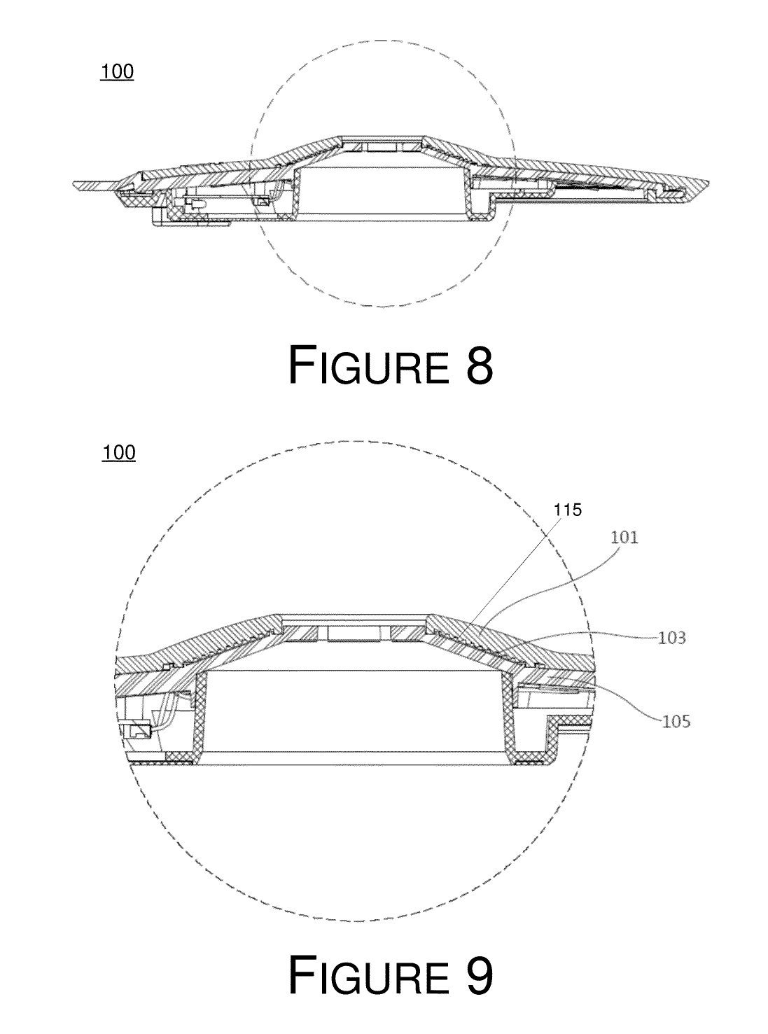

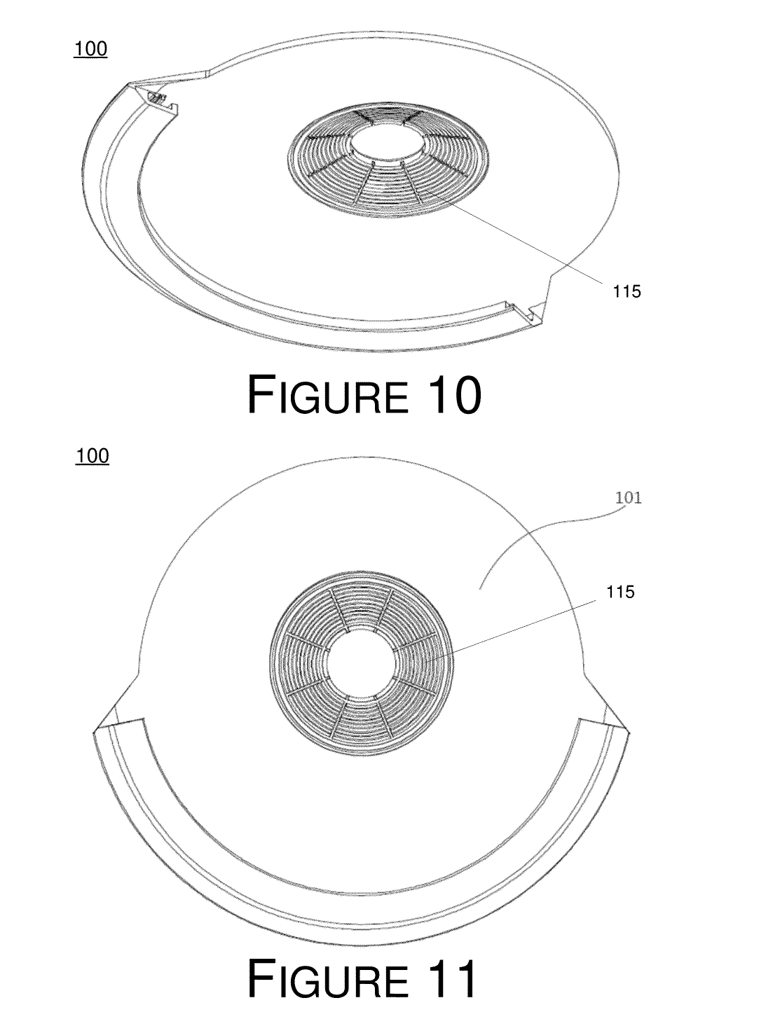

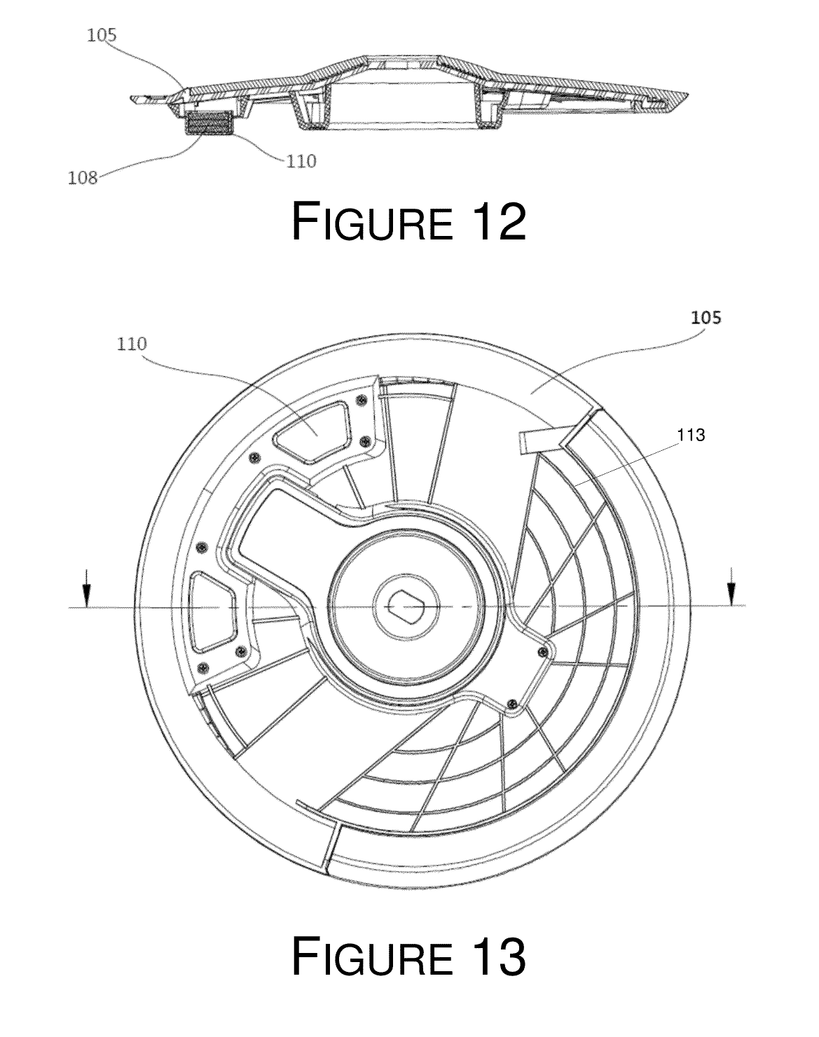

FIGS. 1-14 are various views of an electronic cymbal assembly 100 of an electronic percussion instrument in accordance with an implementation of the present disclosure. Description below regarding electronic cymbal assembly 100 is made with reference to FIGS. 1-14.

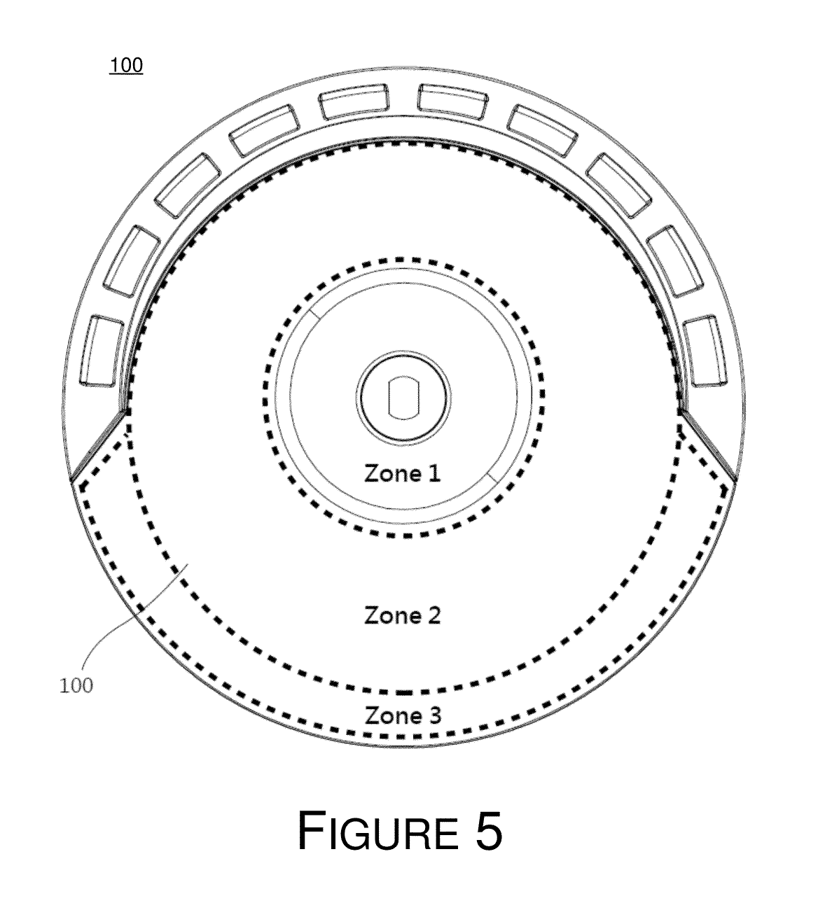

As shown in FIG. 5, electronic cymbal assembly 100 is designed with multiple percussion zones such as, for example, Zone 1, Zone 2 and Zone 3, with Zone 2 being between Zone 1 and Zone 3. Zone 1 may be referred to as the “bell zone” or “bell” herein, Zone 2 may be referred to as the “tip zone” or “tip” herein, and Zone 3 may be referred to as the “edge zone” or “edge” herein. With this design, an electronically-simulated sound that resembles the percussion of a conventional cymbal may be generated by electronic cymbal assembly 100 when any one of the multiple percussion zones is percussed by a user. More specifically, an electronically-simulated sound resembling the percussion of the bell portion of a conventional cymbal may be generated by electronic cymbal assembly 100 when Zone 1 of electronic cymbal assembly 100 is percussed by the user. An electronically-simulated sound resembling the percussion of the tip portion of a conventional cymbal may be generated by electronic cymbal assembly 100 when Zone 2 of electronic cymbal assembly 100 is percussed by the user. An electronically-simulated sound resembling the percussion of the edge portion of a conventional cymbal may be generated by electronic cymbal assembly 100 when Zone 3 of electronic cymbal assembly 100 is percussed by the user.

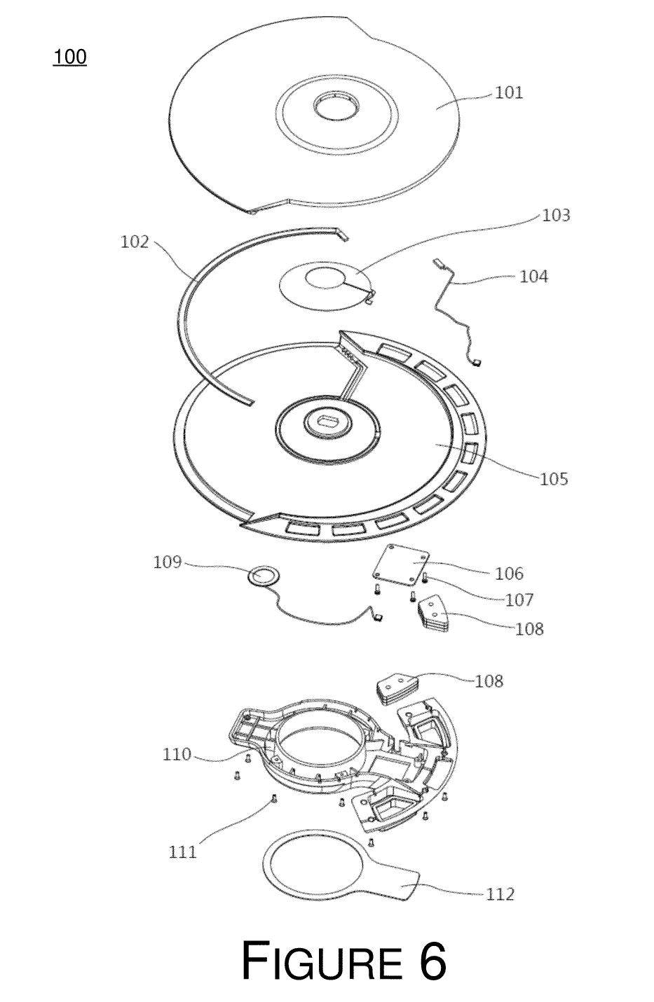

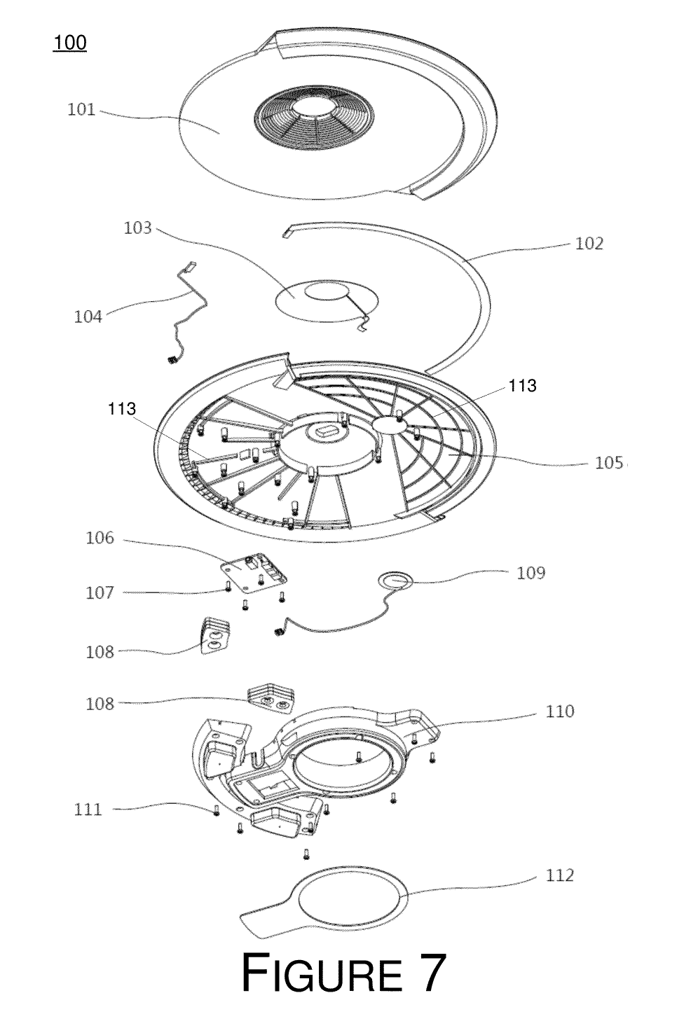

In some embodiments, electronic cymbal assembly 100 may include a main cymbal seat, a percussion detection module and an electronics module. As shown in FIGS. 6 and 7, in some embodiments, electronic cymbal assembly 100 may be constructed with components including the following: elastic percussion pad 101, edge sensor 102, bell sensor 103, connection cable 104, main cymbal seat 105, circuit board 106, circuit board screws 107, one or more counter-weight pieces 108, tip sensor 109, backside cover 110, backside cover screws 111 and backside cover screw cover plate 112. In the example shown in FIGS. 6 and 7, the percussion detection module may include elastic percussion pad 101, edge sensor 102, bell sensor 103 and tip sensor 109. Likewise, in the example shown in FIGS. 6 and 7, the electronic module may include connection cable 104, circuit board 106 and circuit board screws 107.

Main cymbal seat 105 may include a first primary side (e.g., the top side shown in FIGS. 1-14) and a second primary side opposite the first primary side (e.g., the bottom side shown in FIGS. 1-14). Main cymbal seat 105 may be configured with multiple percussion zones corresponding to the multiple percussion zones of electronic cymbal assembly 100, e.g., Zone 1, Zone 2 and Zone 3. The percussion detection module may include multiple sensors (e.g., bell sensor 103, tip sensor 109 and edge sensor 102) that are disposed on main cymbal seat 105 to detect percussion of one or more of the multiple percussion zones of main cymbal seat 105 to generate a first electrical signal in response to detecting the percussion. That is, the percussion detection module may include one or more sensors for each of the percussion zones. Each, some or all of the sensors of the percussion detection module may be a piezoelectric sensor. Alternatively, each, some or all of the sensors of the percussion detection module may be a sheet sensor. For example, each of bell sensor 103 and edge sensor 102 may be a sheet sensor, and tip sensor 109 may be a piezoelectric sensor. The electronics module may be communicatively coupled, e.g., by connection cable 104, to receive the first electrical signal from the percussion detection module and configured to provide a second electrical signal configured to generate an electronic percussion sound, e.g., via one or more speakers.

In the example shown in FIGS. 1-14, the percussion detection module may include bell sensor 103, edge sensor 102 and tip sensor 109, each of which corresponding to a respective one of the multiple percussion zones of main cymbal seat 105. For instance, bell sensor 103 may be disposed in Zone 1 (the bell-shaped portion) of main cymbal seat 105, tip sensor 109 may be disposed in Zone 2 of main cymbal seat 105, and edge sensor 102 may be disposed in Zone 3, e.g., along the rim, of main cymbal seat 105.

In at least some implementations, bell sensor 103 and edge sensor 102 may be disposed on the first primary side of main cymbal seat 105, and tip sensor 109 may be disposed on the second primary side of main cymbal seat 105.

In at least some implementations, bell sensor 103 may be tapered such that a normal of a primary sensing surface of bell sensor 103 is offset from a normal of the first primary side of main cymbal seat 105. Bell sensor 103 may be flat in shape. When it is disposed on the surface of the bell-shaped portion, or Zone 1, of main cymbal seat 105 it is tapered so that it is more sensitive than if not so positioned or oriented.

In at least some implementations, main cymbal seat 105 may further include at least one rib 113 protruding out of the second primary side thereof. In at least some implementations, the at least one rib 113 may include a plurality of ribs arranged in a mesh-like pattern, as shown in FIGS. 2, 7 and 13.

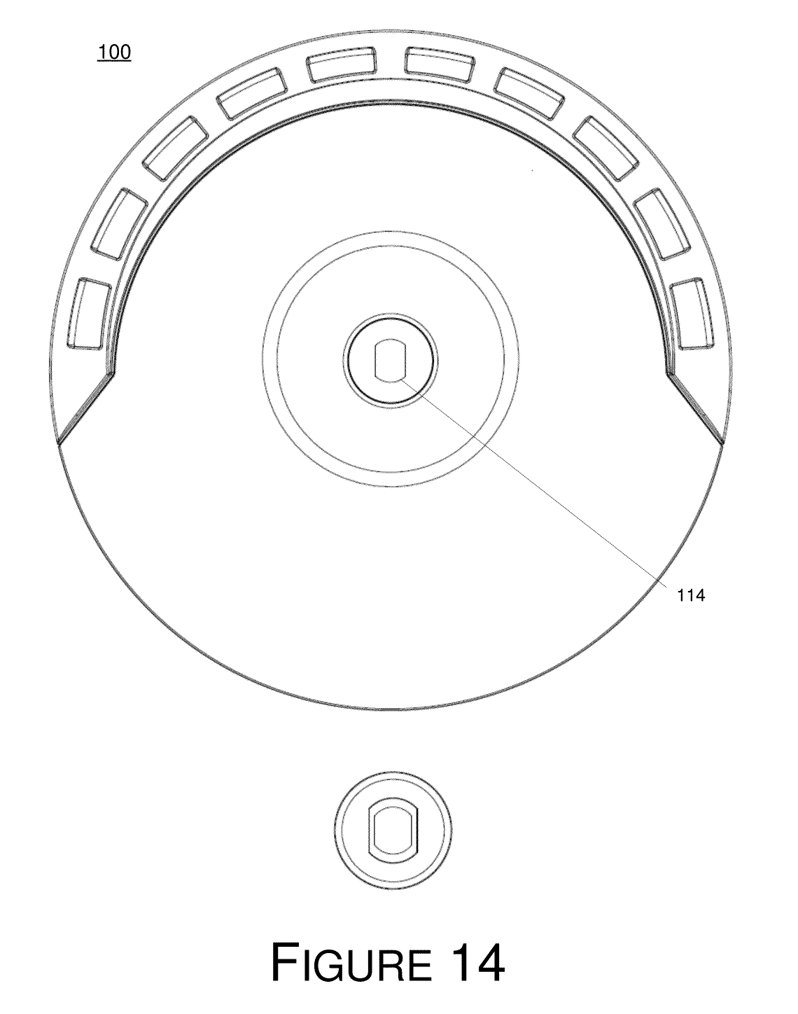

In at least some implementations, main cymbal seat 105 may further include a capsule-shaped through-hole 114 in a middle portion thereof, as shown in FIG. 14. Capsule-shaped through-hole 114 may be configured such that, when the electronic cymbal assembly 100 is installed on a shaft of a conventional cymbal stand with the shaft traversing through capsule-shaped through-hole 114, capsule-shaped through-hole 114 prevents electronic cymbal assembly 100 from spinning around the shaft.

In at least some implementations, a first counter-weight piece of the one or more counter-weight pieces 108 may be configured to balance a weight of electronic cymbal assembly 100 when electronic cymbal assembly 100 swings when being percussed. Additionally, a second counter-weight piece of the one or more counter-weight pieces 108 may be configured to reduce vibration of at least the main cymbal seat 105. Backside cover 110 is configured to accommodate or otherwise receive the one or more counter-weight pieces 108 therein.

In at least some implementations, elastic percussion pad 101 may be disposed on the first primary side of main cymbal seat 105 with one or more sensors of the percussion detection module disposed between elastic percussion pad 101 and main cymbal seat 105. For example, bell sensor 103 and edge sensor 102 may be disposed on the first primary side of main cymbal seat 105 and between elastic percussion pad 101 and main cymbal seat 105.

In at least some implementations, as shown in FIGS. 9-11, at least a portion of a surface of elastic percussion pad 101 that faces main cymbal seat 105 may include at least one rib 115 configured to be in physical contact with at least one sensor of the percussion detection module (e.g., bell sensor 103). In at least some implementations, the at least one rib 115 of elastic percussion pad 101 may include a plurality of concentric ribs 115 configured to be disposed on and around a bell-shaped portion of main cymbal seat 105. Accordingly, the concentric ribs 115 may more easily press on the one or more sensors of the percussion detection module disposed in Zone 1 (e.g., bell sensor 103) when elastic percussion pad 101 is percussed or hit by a user. This design feature helps improve the accuracy of detection of the percussion as well as the accuracy of the electrical signal generated by the one or more sensors disposed between elastic percussion pad 101 and main cymbal seat 105.

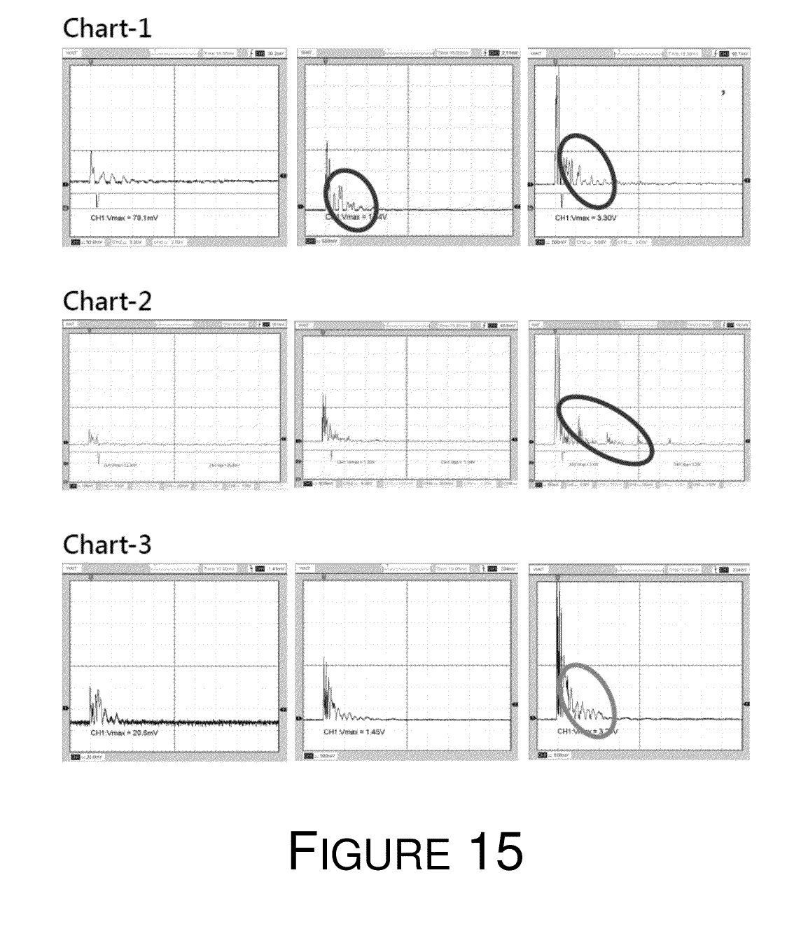

FIG. 15 shows a comparison of charts of detected signals by different electronic cymbal assemblies. Chart 1 shows an electrical signal generated by an electronic cymbal assembly having an overall diameter of less than 10 inches and without any rib on the second primary side (e.g., bottom side) thereof. As shown in Chart 1, the electrical signal is not smooth and breaks off, which means the signal may be detected as multiple smaller signals. In other words, the accuracy of the detected signal is negatively affected. Chart 2 shows an electrical signal generated by an electronic cymbal assembly having an overall diameter of about 13 to 14 inches and without any rib on the second primary side (e.g., bottom side) thereof. As shown in Chart 2, the electrical signal is not smooth and breaks off, which means the signal may be detected as multiple smaller signals. In other words, the accuracy of the detected signal is negatively affected. Chart 3 shows an electrical signal generated by an electronic cymbal assembly 100, which may have an overall diameter of about 13 to 14 inches and with at least one rib on the second primary side (e.g., bottom side) thereof. As shown in Chart 3, the signal is smoother compared to that shown in Chart 1 and Chart 2, and the signal is continuous rather than broken off. As can be seen, the detected signal is better or more accurate than that detected by electronic cymbal assemblies that do not have any rib or rib-like structure on the second primary side (e.g., bottom side) thereof.

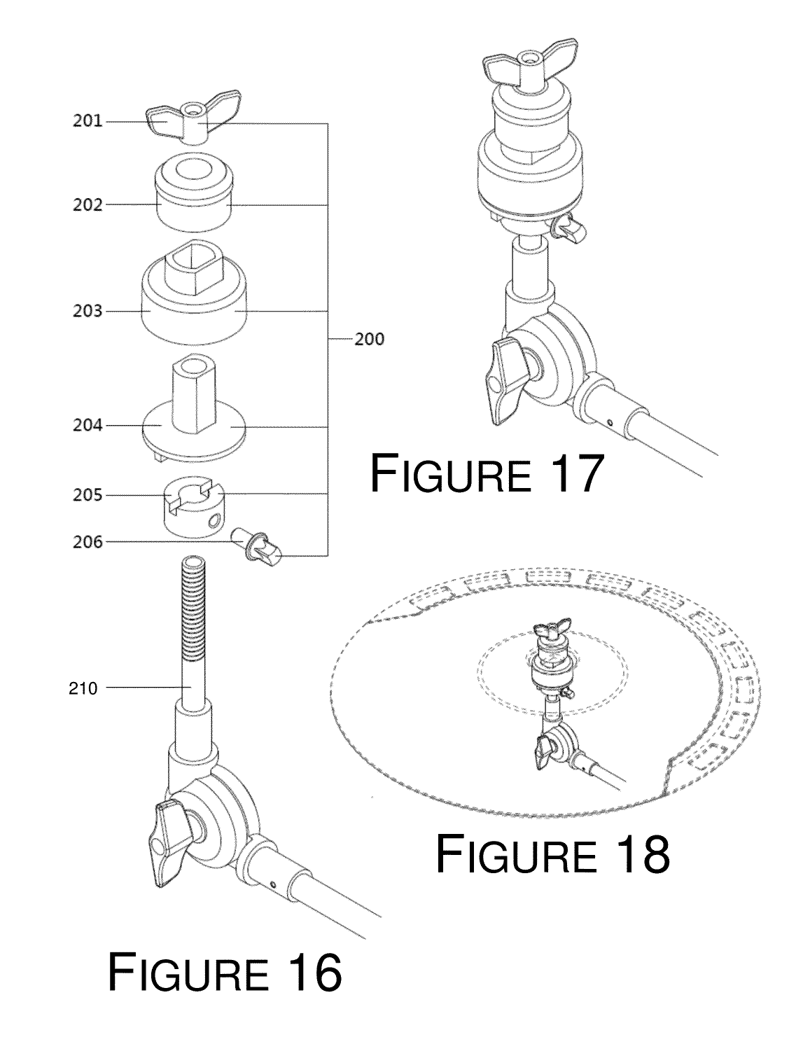

FIGS. 16-18 show various views of an anti-spin module 200 of an electronic percussion instrument in accordance with an implementation of the present disclosure. Description below regarding anti-spin module 200 is made with reference to FIGS. 16-18.

Anti-spin module 200 may be utilized in conjunction with electronic cymbal assembly 100. Anti-spin module 200 may include, for example, a lock rim 205, a rubber holder seat 204, a lower rubber holder 203 and an upper rubber holder 202. Anti-spin module 200 may also include wing nut 201 and lock rim screw 206. Lock rim 205 may include a through-hole and configured to be installed on a tilter shaft 210 of a conventional cymbal stand with tilter shaft 210 traversing through the through-hole of lock rim 205. Lock rim screw 206 may be configured to secure lock rim 205 on tilter shaft 210, and wing nut 201 may be configured to secure upper rubber holder 202 on lower rubber holder 203.

Lock rim 205 may also include two trenches. Rubber holder seat 204 may be configured to be installed on tilter shaft 210 of the conventional cymbal stand. Rubber holder seat 204 may include two ribs configured to be accommodated in the two trenches of lock rim 205 when rubber holder seat 204 is installed on tilter shaft 210. Rubber holder seat 204 may also include a first collar protruding in a direction along tilter shaft 210 when rubber holder seat 204 is installed on tilter shaft 210. Lower rubber holder 203 may include a through-hole that fits around the first collar of rubber holder seat 204 when lower rubber holder 203 is installed on tilter shaft 210. Lower rubber holder 203 may include a second collar protruding in a direction along tilter shaft 210 when lower rubber holder 203 is installed on tilter shaft 210. The second collar may include a capsule-shaped cross-sectional profile configured to fit in capsule-shaped through-hole 114 of main cymbal seat 105. Upper rubber holder 202 may be configured to be installed on tilter shaft 210 of the conventional cymbal stand such that electronic cymbal assembly 100 is disposed between upper rubber holder 202 and lower rubber holder 203.

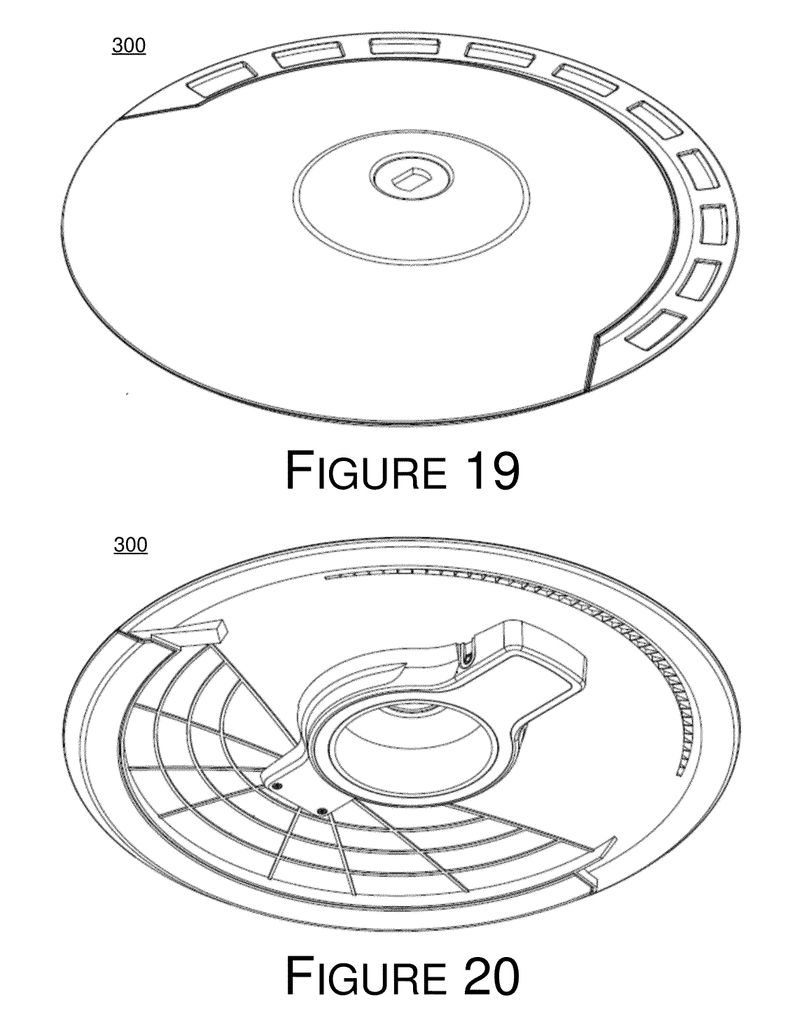

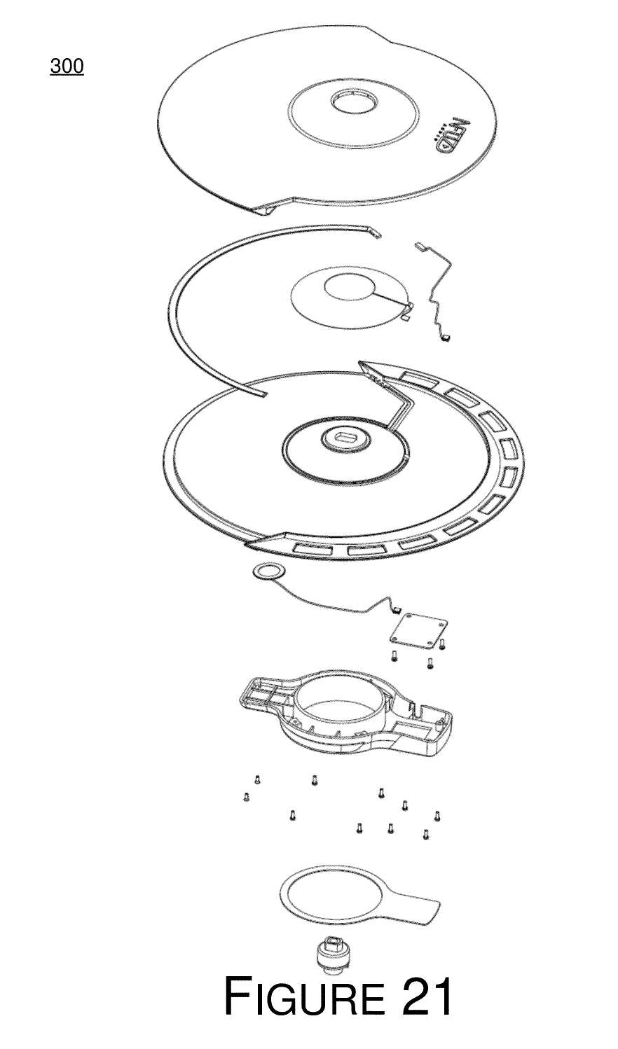

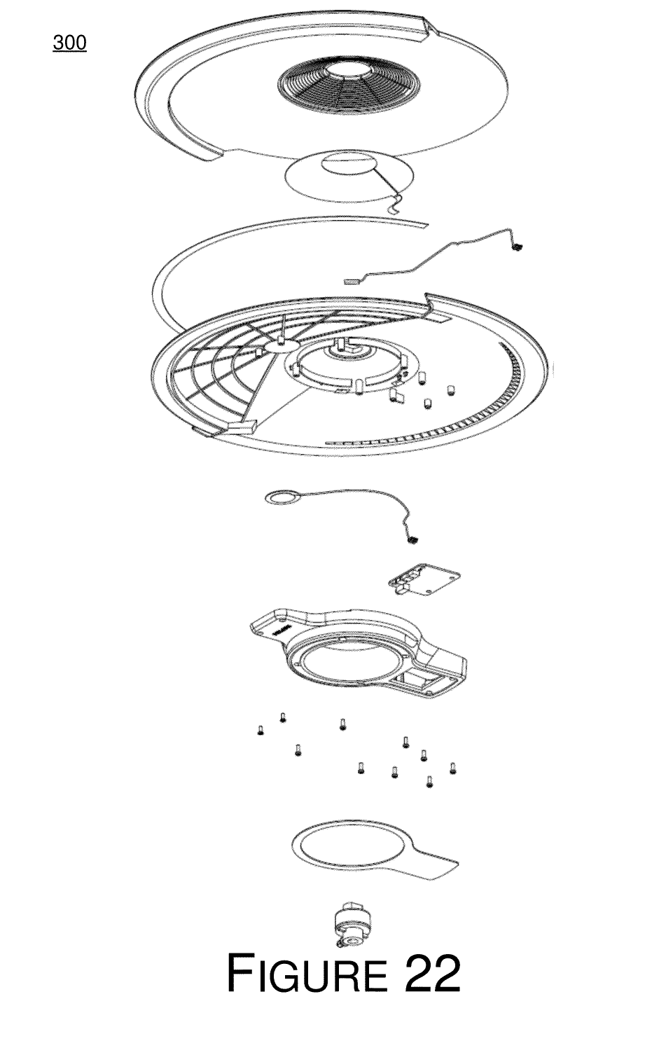

FIGS. 19-22 are various views of an electronic cymbal assembly 300 of an electronic percussion instrument in accordance with an implementation of the present disclosure. Description below regarding electronic cymbal assembly 300 is made with reference to FIGS. 19-22.

Electronic cymbal assembly 300 is similar to electronic cymbal assembly 100 and, thus, detailed description thereof is limited to the difference(s) between electronic cymbal assembly 300 and electronic cymbal assembly 100 in the interest of brevity. As shown in FIGS. 19-22, electronic cymbal assembly 300 differs from electronic cymbal assembly 100 in that electronic cymbal assembly 300 is not configured with any counter-weight piece. Accordingly, the backside cover of electronic cymbal assembly 300 is shaped differently than backside cover 110 of electronic cymbal assembly 100 since there is no counter-weight piece to be accommodated or received by the backside cover of electronic cymbal assembly 300.

In view of the above, select highlights of various implementations of an electronic cymbal assembly of the present disclosure are summarized below.

Firstly, a main cymbal seat of an electronic cymbal assembly in accordance with the present disclosure is configured with multiple percussion zones with one or more sensors corresponding to each zone to detect the percussion thereof. In the illustrated examples, the multiple percussion zones may include a bell zone, a tip zone and an edge zone. The one or more sensor corresponding to the bell zone may be tapered in its orientation with respect to a horizontal surface so that the one or more sensor corresponding to the bell zone may be more sensitive and, thus, may more accurately generate an electrical signal in response to detecting a percussion of the bell zone of the main cymbal seat of the electronic cymbal assembly. Secondly, the main cymbal seat is configured with one or more ribs to promote the detection of percussion of a relatively larger area and generate a more stable electrical signal. Thirdly, one or more counter-weight pieces may be provided on the bottom side of the electronic cymbal assembly. One benefit is that the weight of the electronic cymbal assembly may be balanced when the electronic cymbal assembly swings back and forth like a conventional cymbal. Another benefit is that the one or more counter-weight pieces. This can help reduce vibration of the electronic cymbal assembly and help better detection of percussion and generation of corresponding electrical signals. Additionally, with a capsule-shaped through-hole in the center of the main cymbal seat and with the aid of the anti-spin module, the electronic cymbal assembly is prevented from spinning around the tilter shaft. The anti-spin module can lock the electronic cymbal seat on a tilter shaft of a conventional cymbal stand. The anti-spin module may also be used to adjust an orientation of the electronic cymbal assembly so that a user can hit the right zone(s) of the electronic cymbal assembly.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations.

Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. An electronic percussion instrument, comprising:
an electronic cymbal assembly comprising:
a main cymbal seat comprising a first primary side and a second primary side opposite the first primary side, the main cymbal seat further comprising a plurality of percussion zones;
a percussion detection module disposed on the main cymbal seat, the percussion detection module configured to detect percussion of one or more of the plurality of percussion zones and further configured to generate a first signal in response to the detecting; and
an electronics module communicatively coupled to receive the first signal from the percussion detection module and configured to provide a second signal configured to generate an electronic percussion sound.

2. The electronic percussion instrument of claim 1, wherein the percussion detection module comprises a plurality of sensors each of which corresponding to a respective one of the plurality of percussion zones.

3. The electronic percussion instrument of claim 2, wherein the plurality of sensors comprise a first sensor, a second sensor and a third sensor, wherein the first sensor is disposed in a first percussion zone of the plurality of percussion zones on a bell-shaped portion of the main cymbal seat, wherein the third sensor is disposed in a third percussion zone of the plurality of percussion zones along a rim of the main cymbal seat, and wherein the second sensor is disposed in a second percussion zone of the plurality of percussion zones between the first percussion zone and the third percussion zone of the main cymbal seat.

4. The electronic percussion instrument of claim 3, wherein the first sensor and the third sensor are disposed on the first primary side of the main cymbal seat, and wherein the second sensor is disposed on the second primary side of the main cymbal seat.

5. The electronic percussion instrument of claim 3, wherein the first sensor is tapered such that a normal of a primary sensing surface of the first sensor is offset from a normal of the first primary side of the main cymbal seat.

6. The electronic percussion instrument of claim 1, wherein the main cymbal seat further comprises at least one rib protruding out of the second primary side thereof.

7. The electronic percussion instrument of claim 6, wherein the at least one rib comprises a plurality of ribs arranged in a mesh-like pattern.

8. The electronic percussion instrument of claim 1, wherein the main cymbal seat further comprises a capsule-shaped through-hole in a middle portion thereof, the capsule-shaped through-hole configured such that, when the electronic cymbal assembly is installed on a shaft of a conventional cymbal stand with the shaft traversing through the capsule-shaped through-hole, the capsule-shaped through-hole prevents the electronic cymbal assembly from spinning around the shaft.

9. The electronic percussion instrument of claim 1, further comprising:
first and second counter-weight pieces mounted on the second primary side of the main cymbal seat, the first counter-weight piece configured to balance a weight of the electronic cymbal assembly when the electronic cymbal assembly swings when being percussed, the second counter-weight piece configured to reduce vibration of at least the main cymbal seat.

10. The electronic percussion instrument of claim 1, further comprising:
an elastic percussion pad disposed on the first primary side of the main cymbal seat with one or more sensors of the percussion detection module disposed between the elastic percussion pad and the main cymbal seat.

11. The electronic percussion instrument of claim 10, wherein at least a portion of a surface of the elastic percussion pad that faces the main cymbal seat comprises at least one rib configured to be in physical contact with at least one sensor of the percussion detection module.

12. The electronic percussion instrument of claim 11, wherein the at least one rib of the elastic percussion pad comprises a plurality of concentric ribs configured to be disposed on and around a bell-shaped portion of the main cymbal seat.

13. The electronic percussion instrument of claim 1, further comprising:
an anti-spin module comprising:
a lock rim comprising a through-hole and configured to be installed on a shaft of a conventional cymbal stand with the shaft traversing through the through-hole of the lock rim, the lock rim further comprising two trenches;
a rubber holder seat configured to be installed on the shaft of the conventional cymbal stand, the rubber holder seat comprising:
two ribs configured to be accommodated in the two trenches of the lock rim when the rubber holder seat is installed on the shaft; and
a first collar protruding in a direction along the shaft when the rubber holder seat is installed on the shaft;
a lower rubber holder comprising a through-hole that fits around the first collar of the lower rubber holder seat when the lower rubber holder is installed on the shaft, the lower rubber holder comprising a second collar protruding in a direction along the shaft when the lower rubber holder is installed on the shaft, the second collar having a capsule-shaped cross-sectional profile configured to fit in the capsule-shaped through-hole of the main cymbal seat; and
an upper rubber holder configured to be installed on the shaft of the conventional cymbal stand such that the electronic cymbal assembly is disposed between the upper rubber holder and the lower rubber holder.

14. An electronic percussion instrument, comprising:
an electronic cymbal assembly comprising:
a main cymbal seat comprising a first primary side and a second primary side opposite the first primary side, the main cymbal seat further comprising a capsule-shaped through-hole and configured to be installed on a shaft of a conventional cymbal stand with the shaft traversing through the capsule-shaped through-hole such that the capsule-shaped through-hole prevents the electronic cymbal assembly from spinning around the shaft;
a percussion detection module disposed on the main cymbal seat and configured to detect percussion of the main cymbal seat to generate a first signal in response to the detecting; and
an electronics module communicatively coupled to receive the first signal from the percussion detection module and configured to provide a second signal configured to generate an electronic percussion sound.

15. The electronic percussion instrument of claim 14, wherein the main cymbal seat further comprises a plurality of percussion zones, and wherein the percussion detection module is configured to detect percussion of one or more of the plurality of percussion zones.

16. The electronic percussion instrument of claim 15, wherein the percussion detection module comprises a plurality of sensors each of which corresponding to a respective one of the plurality of percussion zones.

17. The electronic percussion instrument of claim 16, wherein the plurality of sensors comprise a first sensor, a second sensor and a third sensor, wherein the first sensor is disposed in a first percussion zone of the plurality of percussion zones on a bell-shaped portion of the main cymbal seat, wherein the third sensor is disposed in a third percussion zone of the plurality of percussion zones along a rim of the main cymbal seat, and wherein the second sensor is disposed in a second percussion zone of the plurality of percussion zones between the first percussion zone and the third percussion zone of the main cymbal seat.

18. The electronic percussion instrument of claim 17, wherein the first sensor and the third sensor are disposed on the first primary side of the main cymbal seat, and wherein the second sensor is disposed on the second primary side of the main cymbal seat.

19. The electronic percussion instrument of claim 17, wherein the first sensor is tapered such that a normal of a primary sensing surface of the first sensor is offset from a normal of the first primary side of the main cymbal seat.

20. The electronic percussion instrument of claim 15, wherein the main cymbal seat further comprises at least one rib protruding out of the second primary side thereof.
